(19) United States
(12) Patent Application Publication
(10) Pub. No.: US 2007/0274271 A1
(43) Pub. Date: Nov. 29, 2007

(54) WIRELESS COMMUNICATION DEVICE HAVING DUAL TRANSCEIVERS FOR NETWORK PAIRING WITH ANOTHER DEVICE

(75) Inventors: Shawn Michael Jones, Cary, IL (US); Jeremy Thomas Jobling, Deerfield, IL (US); Sang Yoon Ho, Lake Zurich, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/420,305

(22) Filed: May 25, 2006

(51) Int. Cl. H04Q 7/24

(52) U.S. Cl. 370/338

(57) ABSTRACT

A system and method for network pairing with two or more wireless communication devices, in which each device includes at least two wireless transceivers. For each device, one wireless transceiver has indirect communication with the other communication device via a first connection, and another wireless transceiver that is capable of direct communication with the other communication device via a second connection based on an ad hoc protocol. The wireless transceivers of the wireless communication devices exchange network address information needed for paired communication between the devices through the first connection, thus minimizing the need to search and discovery for paired communication for the second connection.

### FIELD OF THE INVENTION

The present invention relates generally to the field of network pairing of wireless communication devices. More particularly, the present invention relates to wireless communication devices capable of pairing for ad hoc communication.

### BACKGROUND OF THE INVENTION

Wireless communication devices are capable of communication with other devices via wireless communication links. Examples of wireless communication links include cellular communication links and ad hoc communication links. Generally, cellular communication links communicate through network infrastructure and utilize wireless communication protocols such as AMPS, CDMA, TDMA, GSM, iDEN, GPRS, EDGE, UMTS, WCDMA, CDMA2000, and their variants. Ad hoc communication links, on the other hand, communicate peer-to-peer and utilize wireless communication protocols such as HomeRF, Bluetooth, IEEE 802.11, IEEE 802.16, infrared technology, and the like.

Ad hoc communication links require some sort of pairing between devices in which the devices discover each other and network addresses of the devices are exchanged in a secure manner. For existing systems, pairing of wireless communication devices for ad hoc communication, such as a Bluetooth connection, requires one device to be discoverable and another device to search the discoverable device. It is necessary for the two devices to be in proximity of each other, and act in tandem. Also, the pairing process of the ad hoc network is not very consumer friendly, because the users of the devices may need to have a technical understanding of the process.

There is a need for a wireless communication device that is capable of network pairing with another device to form an ad hoc communication link in a way that is friendly to the average consumer. There is also a need for network pairing of wireless communication devices that are remote from each so that, when the devices are eventually within proximity of each other, they may immediately communicate with each other over the ad hoc communication link.

### BRIEF DESCRIPTION OF THE DRAWINGS

FIG. 1 is a system view of a preferred embodiment in accordance with the present invention.

FIG. 2 is a block diagram illustrating exemplary components of the wireless communication devices of FIG. 1.

FIG. 3 is flow diagram illustrating an operation of one wireless communication device of FIG. 1.

FIG. 4 is flow diagram illustrating an operation of another wireless communication device of FIG. 1, in communication with the device executing the operation of FIG. 3 or similar operation.

### DETAILED DESCRIPTION OF THE EMBODIMENTS

A system and method for network pairing with two or more wireless communication devices, in which each device includes at least two wireless transceivers. For each device, one transceiver is capable of setting-up paired communication and the other transceiver is capable of paired communication based on the setup of the first transceiver. In particular, one set of wireless transceivers of the communication devices exchange network address information needed for paired communication between the other set of wireless transceivers of the devices, thus minimizing the need to search and discovery for paired communication.

For one embodiment, the wireless communication devices perform Bluetooth pairing over SMS (Short Messaging System) of a mobile phone. For Bluetooth devices having access to a cellular network, the Bluetooth addresses needed for pairing can be sent via SMS messaging. The Bluetooth address can be coded into an SMS text message by one Bluetooth device. The Bluetooth device that receives the SMS message decodes the message and stores the Bluetooth address in its device pairing history. By utilizing this invention, the user interfaces of the Bluetooth devices may be more consumer friendly so that end users do not need to be involved with any technical details relating to Bluetooth pairing and communication. For the initiating device, the user would select a menu item to activate network pairing and, then, select an identity and associated Bluetooth address corresponding to the other device from its address book or phone book. The user of the other device receives the text message and only views a query on its display that asks whether to accept the incoming information.

In addition, each device may exchange Bluetooth address information necessary for pairing without being in proximity, i.e., within communication range for paired communication, of the other device. Each device would have access to a cellular network and the other device's network address for the cellular network, such as a phone number. The pairing process is simplified, thus addressing one of the more confusing aspects of using Bluetooth devices.

One aspect of the present invention is a wireless communication device for network pairing with a remote communication device comprising first and second wireless transceivers. The first wireless transceiver has a cellular communication link with the remote communication device. The second wireless transceiver is capable of having an ad hoc communication link with the remote communication device. The first wireless transceiver is capable of exchanging ad hoc addresses with the remote communication device via the cellular communication link. The second wireless transceiver is capable of forming the ad hoc communication link based on the ad hoc addresses exchanged via the first wireless transceiver.

Another aspect of the present invention is a method of a wireless communication device. The wireless communication device establishes a cellular communication link with the remote communication device. The wireless communication device then exchanges ad hoc addresses with the remote communication device via the cellular communication link. Thereafter, the wireless communication device forms an ad hoc communication link based on the ad hoc addresses exchanged via the cellular communication link.

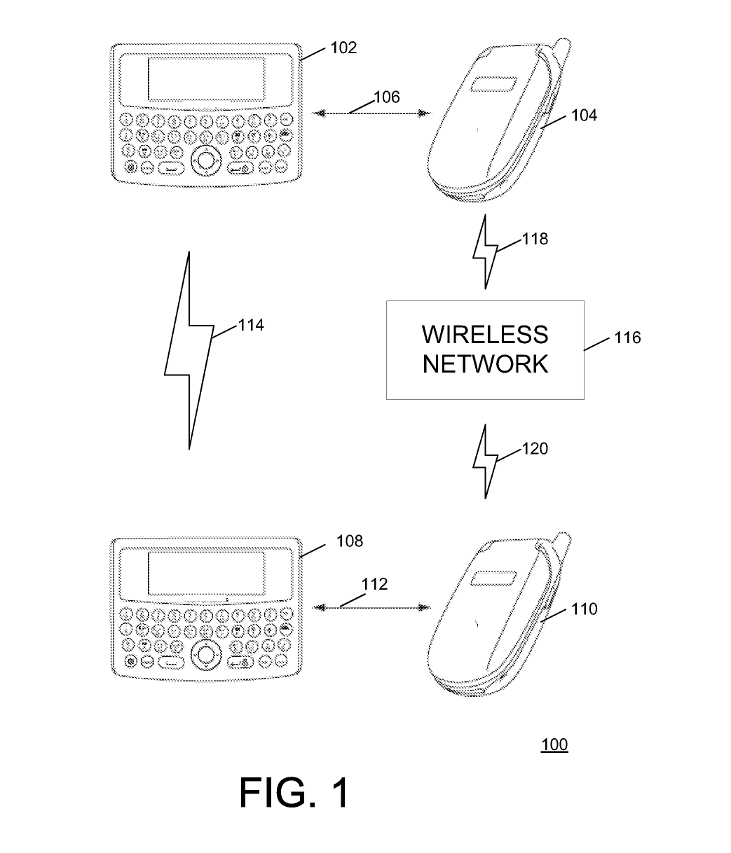

Turning now to the drawings wherein like numerals represent like components, FIG. 1 is a block diagram illustrating a wireless communication system 100 including a wireless communication device 102 for communication one or more remote devices. The wireless communication device 102 may communicate directly with remotely with other devices or, as shown in FIG. 1, communicate indirectly with other devices via one or more intermediate devices. For the embodiment shown in FIG. 1, the wireless communication device 102 communicates with an intermediate device 104 via a wireless ad hoc connection 106. Similarly, each remotely-located wireless communication device 108 may communicate directly with the wireless communication device 102 or communicate indirectly via one or more intermediate devices. For the embodiment shown in FIG. 1, the remote device 108 communicates with an intermediate device 110 via a wireless ad hoc connection 112.

Each wireless communication device 102, 108 includes the capability of communicating with each other via an ad hoc connection 114 when within proximity of another device as required for the ad hoc connection. Each wireless communication device 102, 108 also includes the capability of communicating other devices via a second network connection. The second network connection is a non-ad hoc network connection and/or an indirect network connection. For example, as shown in FIG. 1, in addition to the direct ad hoc connection 114, one wireless communication device 102 may communicate with a first intermediate device 104 via a first ad hoc connection 106 which, in turn, may communicate with a wireless network 116 which, in turn, may communicate with a second intermediate device 110 which, in turn, may communicate with the other wireless communication device 108. Thus, each wireless communication device includes two connections to other devices in which at least one connection is an ad hoc connection. It should be noted that each device may exchange ad hoc information necessary for pairing via the direct ad hoc connection 114 without being in proximity, i.e., within communication range, for paired communication of the other device.

The direct wireless communication link 114 between the wireless communication devices 102, 108 is some form of peer-to-peer or ad hoc communication, such as Bluetooth, HomeRF, IEEE 802.11 (and its variants), or some other form of communication such as infrared. The other wireless communication links 106, 112, 118, 120 utilized by each wireless communication device 102, 104, 108, 110 may also use the above peer-to-peer or ad hoc communication, or utilize a cellular-based communication protocol such as analog communications (using AMPS), digital communications (using CDMA, TDMA, GSM, iDEN, GPRS, or EDGE), and next generation communications (using UMTS, WCDMA or CDMA2000) and their variants.

The wireless communication devices 102, 108 may be any type of communication devices, including any type of form factor, capable of ad hoc communication with other devices. Examples of such form factor include clam/flip, candy bar, slider, keyboard, rotator, touch screen and other form factors commonly known in the industry. For example, as shown in FIG. 1, each wireless communication device 102, 108 may have a full alpha or alphanumeric keyboard with liquid crystal display (LCD) that allows for easy and efficient text messaging using an ad hoc connection to an intermediate device, such as devices 104, 110. The wireless communication device 102, 108 may also use ad hoc communication to connect directly to each other and execute applications that may utilize the ad hoc connection. For example, each device 102, 108 may have a Chat application and communicate directly with each other to give each user an instant messaging-type experience. In order to fully utilize the applications, the devices 102, 108 exchange ad hoc network addresses, such as Bluetooth addresses.

The wireless communication devices 102, 108 are not required to be within range of each other and coordinate a discoverable/searching action. The wireless communication devices 102, 108 offer an easier solution for the users in which ad hoc network addresses may be exchanged via a non-ad hoc communication network, such as a cellular communication network. For one embodiment, each user may select a menu item at a user interface that would allow the user to select a network address from an ad hoc contact list or book. Each wireless communication device 102, 108 may then encode a message with the ad hoc network information which is sent to the other device via the non-ad hoc network. For example, a user may select an “Add Friend” menu item and a contact corresponding to the Friend from the address or phone book. Each device 102, 108 may then encode a text or SMS message with the Bluetooth information, which is sent to the other device. For this example, each device may send the encoded message directly to the other device via a cellular connection, or indirectly to the other device via an ad hoc connection to an intermediate device which, in turn, forwards the information via a cellular connection.

When the wireless communication device 102, 108 at the other end receives the encoded message, the receiving device decodes the message and queries the user of the receiving device whether the sending device, and associated network address, should be added to the ad hoc contact list or book of the receiving device. Also, if the recipient agrees to be added to the sender's ad hoc contact list or book in response to a query for the same, then a return message may be sent to the original sending device with the recipient's information, including the receiving device's network address. For example, Bluetooth information may be exchanged between two wireless communication devices 102, 108 and stored for use when the two devices are within a minimum proximity required for Bluetooth communication.

A wireless communication device 102, 108 may initiate this process where the network address of another device, such as the phone number of the other device, is known. The user interface of the device 102, 108 would have the user select an allow command when prompted without necessitating a discoverable mode or a position within the same vicinity as the other device. This system and method may also be utilized for mobile-to-mobile pairing for any ad hoc related application. In addition, the system and method may be used for any ad hoc-capable devices having access to text or SMS message. For instance, a photo kiosk may send its Bluetooth address to a customer's device so that images may be sent to by the device for printing at the kiosk.

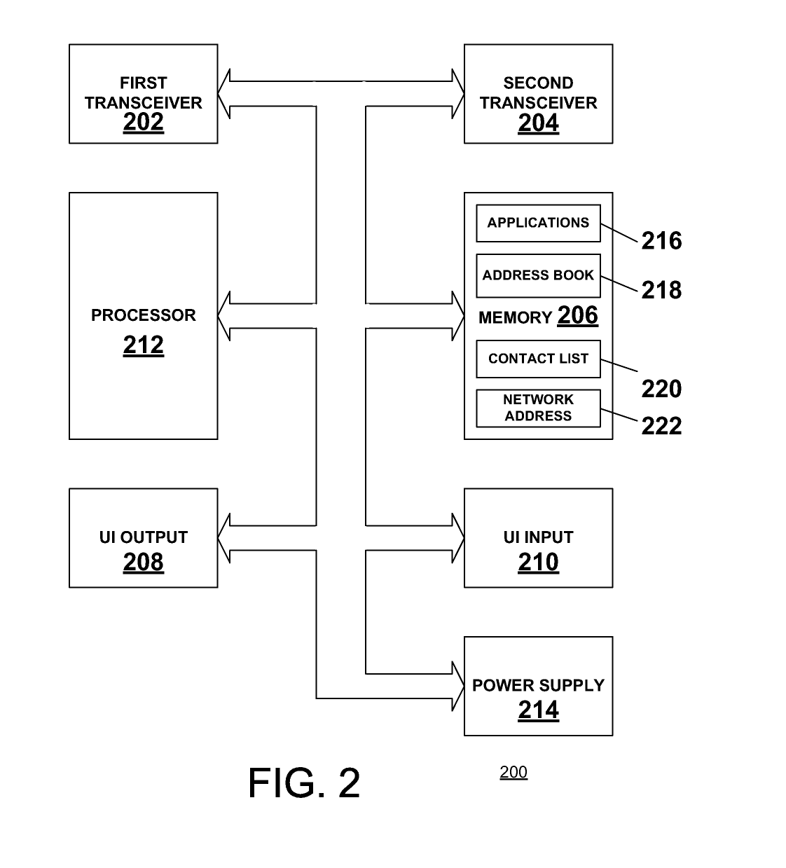

Referring to FIG. 2, there is provided a block diagram illustrating exemplary internal components 200 of the wireless communication devices 102, 108, and, for those embodiments that utilize intermediate devices, the block diagram may also exemplify wireless communication devices 104, 110, in accordance with the present invention. The exemplary internal components 200 includes one or more wireless transceivers 202, 204 in which at least one transceiver provides ad hoc communication capabilities, a memory portion 206, one or more output devices 208, and one or more input devices 210, and a processor 212. Each embodiment may include a user interface that comprises one or more output devices 208 and one or more input device 210. Each transceiver 202 may utilize wireless technology for communication, such as the wireless communication links or connections described above. The internal components 200 may further include a power supply 214, such as a battery, for providing power to the other internal components while enabling the wireless communication devices 102, 104, 108, 110 to be portable.

The input and output devices 208, 210 of the internal components 200 may include a variety of video, audio and/or mechanical outputs. For example, the output device(s) 208 may include a video output device such as a liquid crystal display and light emitting diode indicator, an audio output device such as a speaker, alarm and/or buzzer, and/or a mechanical output device such as a vibrating mechanism. Likewise, by example, the input devices may include a video input device such as an optical sensor (for example, a camera), an audio input device such as a microphone, and a mechanical input device such as a flip sensor, keyboard, keypad, selection button, touch pad, touch screen, capacitive sensor, motion sensor, and switch. Actions that may actuate one or more input devices 210 include, but not limited to, opening the wireless communication device, unlocking the device, moving the device to actuate a motion, moving the device to actuate a location positioning system, and operating the device.

The memory portion 206 of the internal components 200 may be used by the processor 212 to store and retrieve data. The data that may be stored by the memory portion 206 include, but is not limited to, operating systems, applications 216, and data 218, 220, 222. Each operating system includes executable code that controls basic functions of the communication device, such as interaction among the components of the internal components 200, communication with external devices via the transceivers 202, 204, and storage and retrieval of applications and data to and from the memory portion 206. Each application 216 includes executable code utilizes an operating system to provide more specific functionality for the communication device, such as a messaging application, Bluetooth pairing application or a client application for instant messaging or chat sessions.

Data is non-executable code or information that may be referenced and/or manipulated by an operating system or application for performing functions of the communication device. An example of data stored by the memory portion 206 includes an address book 218, an ad hoc contact list 220 and storage for one or more network addresses 222. An address book 218 includes a list of contacts for sending voice and/or text messages, such as voice calls, SMS messages, and the like. Each entry of an address book 218 may correspond to a network address for addressing each voice and/or text messages, such as telephone numbers for voice calls, SMS or IP addresses for SMS messages, and the like. A ad hoc contact list 210 is similar to an address book 218 in that it includes a list of contacts for sending messages. An ad hoc contact list 210 differs from an address book 218 in that it specifically applies to network addresses used for ad hoc network pairing. For example, an ad hoc contact list for Bluetooth communication may include a list of contacts in which each contact is associated with a Bluetooth address. The network address or addresses 222 shown in FIG. 2 are specifically associated with the wireless communication device maintaining the memory 206. For example, a particular wireless communication device may includes contacts in its address book 218 and/or its ad hoc contact list of various other devices, but may keep its own network addresses 222 in a separate part of memory 206. Of course, in the alternative, the wireless communication device may keep the network addresses associated with itself with the address book 218 and/or ad hoc contact list 220 of the device.

It is to be understood that FIG. 2 is for illustrative purposes only and is for illustrating components of a wireless communication device, such as devices 102, 104, 108 and/or 110, in accordance with the present invention, and is not intended to be a complete schematic diagram of the various components required for a wireless communication device. Therefore, a wireless communication device may include various other components not shown in FIG. 2 and still be within the scope of the present invention.

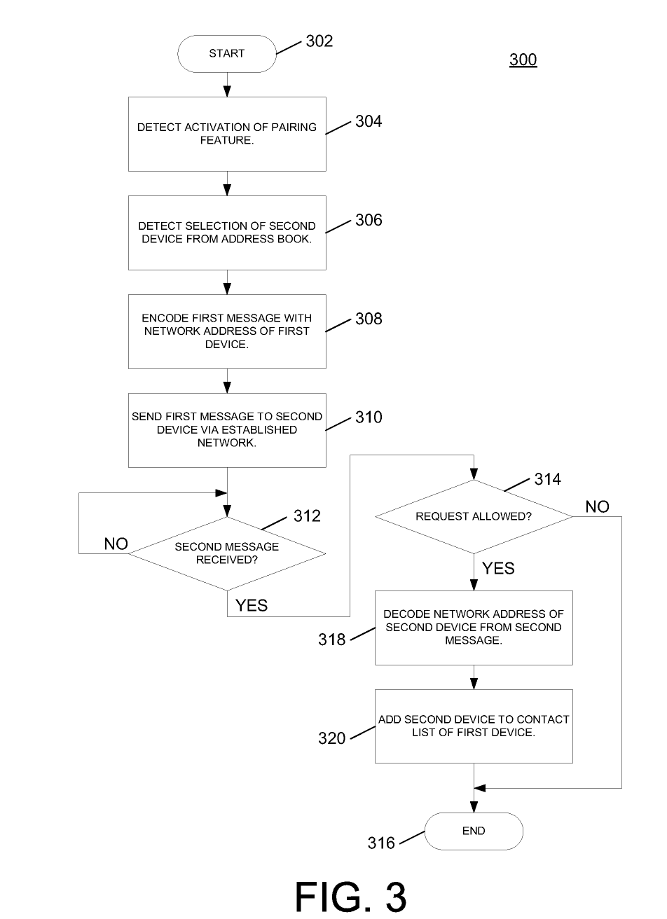

Referring to FIG. 3, there is shown an operation 300 of a wireless communication device, such as device 102 shown in FIG. 1, for network pairing with a remote device. The operation 300 initiates at step 302, and then the wireless communication device 102 detects activation of a pairing feature at step 304. Activation of the pairing feature may be detected at a user interface of the wireless communication device 102, such as input device 210. For example, a user of the wireless communication device 102 may manipulate one or more keypad buttons 210 to select a menu object on a display 208 in order to add a “friend” to the ad hoc contact list of memory 206. The wireless communication device 102 also detects selection of another device from an address book 218 or similar list at step 306. For example, upon selecting a menu object in step 304, the user may manipulate one or more keypad buttons 210 to select a recipient corresponding to a particular device from a recipient list shown in the display 208. Each device selected from the address book 218, or similar list, includes a network address associated with the device. For one embodiment, the network address associated with a selected remote device 108 may be an SMS or IP address for sending a text message, such as an SMS or other text message, to the remote device via one or more intermediate devices, such as devices 104 and/or 110.

As described above, the wireless communication devices 102, 108 may include one or more wireless transceivers 202, 204. If the wireless communication devices 102, 108 include a single wireless transceiver, then the one transceiver has ad hoc communication capabilities, such as a Bluetooth transceiver. The single wireless transceiver of one wireless communication device 102 may then communicate directly with a wireless transceiver of a remote device 108 and communicate indirectly with the remote device through one or more intermediate communication devices, such as devices 104 and/or 110, communicating via a wireless network infrastructure 116. Likewise, each wireless communication device 102, 108 may include one ad hoc wireless transceiver 202 communicating directly with the remote device 108 and another ad hoc wireless transceiver 204 communicating indirectly with the remote device via one or more intermediate devices 104 and/or 110.

If the wireless communication devices 102, 108 include multiple transceivers 202, 204, in which one wireless transceiver 202 has ad hoc communication capabilities and another wireless transceiver 204 has non-ad hoc communication capabilities, then communication through the wireless network 116 may occur without any intermediate devices. For example, one wireless transceiver 202 may communicate directly with a corresponding ad hoc wireless transceiver of a remote device 108 via Bluetooth protocol and another wireless transceiver 204 may communicate with base stations of wireless network infrastructure 116 via a cellular protocol for another connection to the remote device.

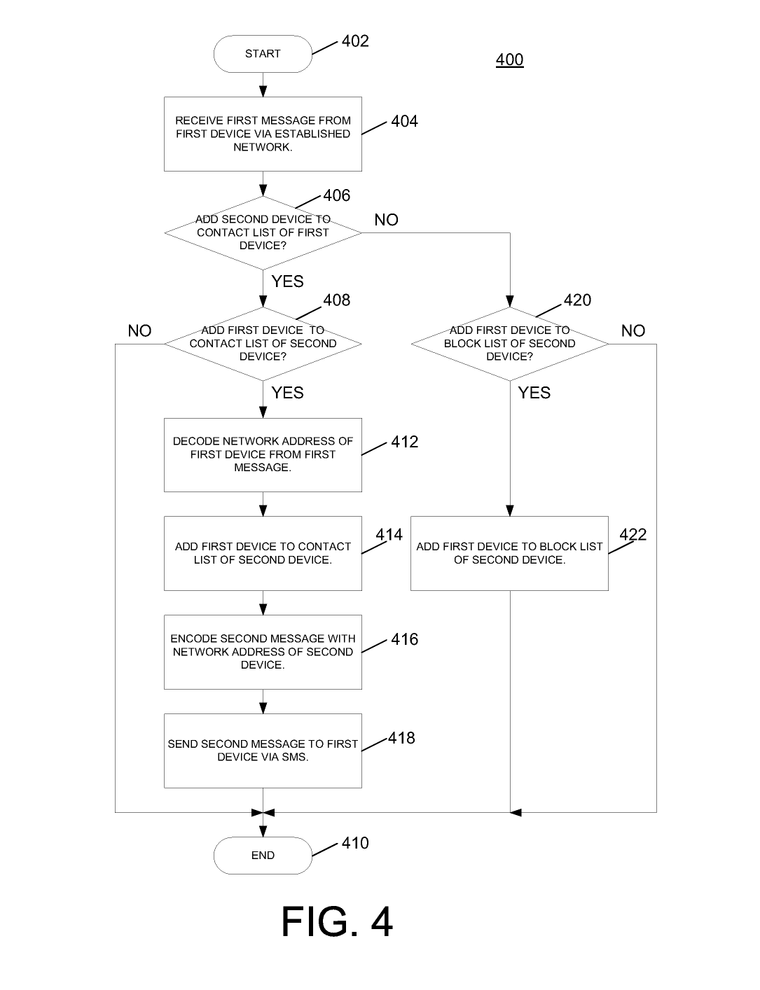

After the wireless communication device 102 detects activation of the pairing feature and selection of another device, the device may encode a first message with a network address associated with the device at step 308. For example, a processor 212 of the wireless communication device 102 may encode its Bluetooth address in an SMS message or other type of text message. Next, the wireless communication device 102 sends the first message to the remote device 108 via an established network connection capable in which at least part of the transmission path is by non-ad hoc network communication means at step 310. In one embodiment, the established network connection of a wireless transceiver 204 may send the first message to a wireless network infrastructure 116 directly via a cellular network connection or, in another embodiment, send the first message to the wireless network infrastructure indirectly via an ad hoc connection to an intermediate device 104, which communicates with the wireless network infrastructure via a cellular network connection. In any case, the first message is sent to the remote device 108 by a wireless communication path other than a direct, ad hoc connection, such as direct wireless communication link 114. Thereafter, the wireless communication device 102 awaits a response from the remote device 108 at step 312. The remaining steps of FIG. 3 are described in more detail below, after the description of FIG. 4.

Referring to FIG. 4, there is shown an operation 400 of a wireless communication device, namely remote device 108, in communication with the wireless communication device 102 executing the operation of FIG. 3 or similar operation. In particular, the operation 400 initiates at step 402, and the remote device 108 receives the first message from the wireless communication device 102 via the established network at step 404. As stated above, the first message includes an ad hoc network address associated with the wireless communication device 102, and is sent by a wireless communication path other than a direct, ad hoc connection, such as direct wireless communication link 114. Next, the remote device 108 determines whether to allow establishment of a direct ad hoc connection, such as direct wireless communication link 114, with the wireless communication device 102 at step 406. If the remote device 108 allows this action, then the device would provide an ad hoc network address, such as its Bluetooth address, to the wireless communication device 102 for addition to the ad hoc contact list 220 of the wireless communication device. For example, the remote device 108 may prompt its user at an output device 208 for a decision, and await the decision at an input device 210.

As part of its decision to allow establishment of a direct ad hoc connection, the remote device 108 may determine whether to add the ad hoc network address of the wireless communication device 102 to the ad hoc contact list 220 of the remote device at step 408. Of course, it is to be understood that the remote device may always allow or always reject the ad hoc network address of the wireless communication device based on a predetermined criteria. It is to be further understood that, for certain embodiments, the remote device 108 may execute step 408 before, concurrently with step 406, or after step 406 as shown in FIG. 4. In any case, if the remote device 108 is not willing to add the ad hoc network address to its ad hoc contact list 220, then operation 400 of FIG. 4 terminates at step 410. If, on the other hand, the remote device 108 is willing to add the ad hoc network address to its ad hoc contact list 220, then the remote device may decode the ad hoc network address of the wireless communication device 102 from the first message at step 412 and add the wireless communication device's information, including the ad hoc network address, to its ad hoc contact list at step 414.

If the remote device 108 decides to allow establishment of a direct ad hoc connection, such as direct wireless communication link 114, with the wireless communication device 102 at step 406 (regardless of if or when steps 408, 412 and 414 are executed), the remote device may encode a second message with a network address associated with the remote device at step 416. For example, a processor 212 of the remote device 108 may encode its Bluetooth address in an SMS message or other type of text message. Next, the remote device 108 sends the second message to the wireless communication device 102 via the established network connection at step 418, in which at least part of the transmission path of the established network connection includes a non-ad hoc network communication means. In one embodiment, the established network connection of a wireless transceiver 204 may send the second message to a wireless network infrastructure 116 directly via a cellular network connection or, in another embodiment, send the second message to the wireless network infrastructure indirectly via an ad hoc connection to an intermediate device 110, which communicates with the wireless network infrastructure via a cellular network connection. In any case, the second message is sent to the wireless communication device 102 by a wireless communication path other than a direct, ad hoc connection, such as direct wireless communication link 114. Thereafter, the operation 400 of FIG. 4 terminates at step 410.

If the remote device 108 does not decide to allow establishment of a direct ad hoc connection with the wireless communication device 102 at step 406, the remote device may take further steps to block the wireless communication device 102 from further communication with the remote device. In particular, the remote device 108 may determine whether to add the wireless communication device 102 to a block list stored in memory 206 of the remote device at step 420. If so, the remote device 108 may add information about the wireless communication device 102, such as an identification or network address, to the block list at step 422. Thereafter, regardless of whether the wireless communication device 102 is added to the block list, the operation 400 of FIG. 4 terminates at step 410.

Referring again to FIG. 3, the wireless communication device 102 awaits a second message from the remote device 108 at step 312. The wireless communication device 102 may expect the second message from the remote device 108 as a response to the first message sent to the remote device at step 310. Upon receiving the second message at its wireless transceiver 204, the wireless communication device 102 determines whether the second message indicates whether the remote device 108 is willing to allow establishment of a direct ad hoc connection, such as direct wireless communication link 114, at step 314. For example, to indicate a willingness to allow establishment of the ad hoc connection, the remote device 108 may include its ad hoc network address in the second message. If the second message does not indicate any willingness by the remote device 108 to form a direct ad hoc connection with the wireless communication device 102, then the operation 300 of FIG. 3 terminates at step 316.

If, on the other hand, the second message indicates any willingness by the remote device 108 to form a direct ad hoc connection with the wireless communication device 102 at step 314, then the wireless communication device may extract or otherwise determine a network address associated with the remote device from the second message at step 318. For example, a processor 212 of the wireless communication device 102 may decode a Bluetooth address associated with the remote device 108 from an SMS message or other type of text message. Thereafter, the wireless communication device 102 adds remote device information, including an ad hoc network address associated with the remote device 108, to its ad hoc contact list 220 at step 320. Upon exchange of ad hoc network addresses, the wireless communication devices 102, 108 are ready for ad hoc communication when in proximity of each other, so the operation of FIG. 3 terminates at step 316.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A wireless communication device for network pairing with a remote communication device comprising:
a first wireless transceiver having a cellular communication link with the remote communication device;
a second wireless transceiver capable of having an ad hoc communication link with the remote communication device,
wherein the first wireless transceiver is capable of exchanging ad hoc addresses with the remote communication device via the cellular communication link and the second wireless transceiver is capable of forming the ad hoc communication link based on the ad hoc addresses exchanged via the first wireless transceiver.

2. The wireless communication device of claim 1, wherein the ad hoc communication link is a Bluetooth connection.

3. The wireless communication device of claim 1, wherein the first wireless transceiver transmits an SMS message to the remote communication device, the SMS message including the ad hoc address of the wireless communication device for communication via the second wireless transceiver.

4. The wireless communication device of claim 1, wherein the first wireless transceiver receives an SMS message from the remote communication device, the SMS message including the ad hoc address of the remote communication device for communication via the second wireless transceiver.

5. A method of a wireless communication device for network pairing with a remote communication device comprising:
establishing a cellular communication link with the remote communication device;
exchanging ad hoc addresses with the remote communication device via the cellular communication link; and
forming an ad hoc communication link based on the ad hoc addresses exchanged via the cellular communication link.

6. The method of claim 5, wherein:
exchanging ad hoc addresses with the remote communication device via the cellular communication link includes exchanging Bluetooth addresses with the remote communication device via the cellular communication link; and
forming an ad hoc communication link based on the ad hoc addresses exchanged via the cellular communication link includes establishing a Bluetooth connection based on the Bluetooth addresses exchanged via the cellular communication link.

7. The method of claim 5, wherein exchanging ad hoc addresses with the remote communication device via the cellular communication link includes transmitting an SMS message via the cellular communication link, wherein the SMS message includes the ad hoc address of the wireless communication device used for communicating over the ad hoc communication link.

8. The method of claim 5, wherein exchanging ad hoc addresses with the remote communication device via the cellular communication link includes receiving an SMS message over the cellular communication link, wherein the SMS message includes the ad hoc address of the remote communication device used for communicating over the ad hoc communication link.
